(19) United States
(12) Patent Application Publication
(10) Pub. No.: US 2007/0079544 A1
(43) Pub. Date: Apr. 12, 2007

(54) Snare trigger assembly

(76) Inventor: Neal H. Domgaard, Duchesne, UT (US)

Correspondence Address: ALAN J. HOWARTH, P.O. BOX 1909, SANDY, UT, 84091-1909, US

(21) Appl. No.: 11/246,571

(22) Filed: Oct. 7, 2005

(51) Int. Cl. A01M 23/34

(52) U.S. Cl. 43/87; 43/85

(57) ABSTRACT

A snare trigger assembly for use in trapping animals that may minimize pelt damage for certain animals. The snare trigger assembly has a rotatable member mounted in a frame. A lever is operable to rotate the rotatable member from a set position to a sprung position in response to an animal tripping a trip wire attached to the lever. A catch coupled to a resilient member engages the rotatable member when the rotatable member is in the set position to thereby maintain a resilient member under tension. When the rotational member is rotated to the sprung position by the lever, the catch is released such that the resilient member is operable to tighten a loop of a snare.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

1. The Field of the Invention

This invention relates generally to animal traps, and more particularly, but not entirely, to trigger mechanisms for snare type animal traps.

2. Description of Related Art

Trapping animals for food, pelts, and control has long been known and practiced. Types of traps vary, and include jaw type traps, cages, and snare traps. Jaw traps generally have two jaws that slam shut on the leg of an animal when the trap is sprung. Cage traps generally trap animals within an enclosure by dropping a trap door when the trap is triggered. Snare traps generally comprise a loop formed in a short wire or cable, i.e., the snare. The loop is formed by slidably fastening one end of the wire or cable to itself to thereby define a loop of variable circumference. The other end of the wire or cable is attached directly or indirectly to a resilient member, such as a spring or a spring loaded arm. The resilient member is maintained under tension by a trigger mechanism. When an animal trips the trigger mechanism, the resilient member is released. When released, the resilient member is operable to quickly draw the loop closed around a portion of the animal, such as a foot, neck, or body of the animal. The snare may include a mechanism that prevents the loop from re-opening once drawn tightly around the animal.

Various types of trigger mechanisms have been previously available for traps, including snare type traps. A trigger mechanism is generally a mechanical device that releases the entrapment means, such as jaws or a snare, when an animal trips the trigger mechanism. One popular type of trigger mechanism involves the use of a trip plate. A trip plate is placed in the anticipated path of an animal. The trap is set by placing a loop of a snare such that the trip plate lies within the boundary formed by the loop. When a part of an animal, such as a foot or head, moves the trip plate, the loop is drawn tight around a portion of the animal. Examples of such trip plate mechanisms are found in U.S. Pat. No. 4,751,790 to Thomas; U.S. Pat. No. 4,581,844 to Torkko; U.S. Pat. No. 4,581,843 to Fremont et al.; U.S. Pat. No. 3,967,408 to Aberg; U.S. Pat. No. 4,561,207 to Novak; U.S. Pat. No. 4,208,827 to Starkey; U.S. Pat. No. 4,329,805 to Novak; U.S. Pat. No. 4,389,807 to Novak; U.S. Pat. No. 5,109,627 to Lee; U.S. Pat. No. 6,016,624 to Rose; and U.S. Pat. No. 6,751,901 to Emond. Other examples include U.S. Pat. No. 5,956,891 to Lee; U.S. Pat. No. 4,920,690 to Olecko; and U.S. Pat. No. 4,601,128 to Danison.

Other types of trigger mechanisms include using the snare loop itself for springing the trap without the use of a trip plate. In these types of traps, the loop is generally suspended vertically in the anticipated path of the animal. An animal traveling down the path will spring the trap when its head or other body part enters the loop and begins to pull the loop tight. This action pulls the end of the snare opposite the loop to thereby release a spring mechanism. When released, the spring mechanism springs the trap and quickly tightens the noose before the animal can escape. Examples of traps of this type are found in U.S. Pat. No. 5,675,928 to Tattrie; U.S. Pat. No. 4,069,612 to King; U.S. Pat. No. 3,958,360 to King; U.S. Pat. No. 4,171,589 to Brownlie; and U.S. Pat. No. 4,757,639 to Bertram.

Despite the advantages of known traps, improvements are still being sought. For example, many of the traps being used today result in significant damage to the pelt of the animal being trapped. Damaged pelts demand a lower market price than undamaged pelts. Further, the recent so-called advances in trap design have resulted in traps of complex and expensive design, having intricate trigger mechanisms.

The prior art is thus characterized by disadvantages that are addressed by the present disclosure. The present disclosure minimizes, and in some aspects eliminates, the above-mentioned failures, and other problems, by utilizing the methods and structural features described herein.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is an exploded view of an exemplary embodiment of a snare trigger assembly pursuant to the present disclosure;

FIG. 2 is a side view of the embodiment illustrated in FIG. 1 shown in the set position;

FIG. 3 is a side view of the embodiment illustrated in FIG. 1 shown in the sprung position;

FIG. 4 is a cross-sectional view of the trigger assembly illustrated in FIG. 1 as shown in FIG. 2;

FIG. 5 is a cross-sectional view of the trigger assembly illustrated in FIG. 1 as shown in FIG. 3;

FIG. 6 is a view of the embodiment illustrated in FIG. 1 deployed in the set position.; and

FIG. 7 is a view of the embodiment illustrated in FIG. 1 deployed in the sprung position.

FIG. 8 is a cross-sectional view of an alternative embodiment of a trigger assembly according to the present invention.

### DETAILED DESCRIPTION

For the purposes of promoting an understanding of the principles in accordance with the disclosure, reference will now be made to the embodiments illustrated in the drawings and specific language will be used to describe them. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the present compositions and methods for a snare trigger assembly are disclosed and described, it is to be understood that this disclosure is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present disclosure will be limited only by the appended claims and equivalents thereof.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and grammatical equivalents thereof are inclusive or open-ended terms that do not exclude additional, unrecited elements or method steps.

Applicant has discovered a trigger assembly for snare type animal traps that is simple in design and is able to trap animals without damage to the animal's pelt. While the Applicant's invention is particularly suited for trapping beavers by their tails, it should be understood that the trigger assembly of the present disclosure may be used to trap various types of animals, whether for pelts, food, or control. The trigger assembly of the present disclosure may be varied in size and material to accommodate animals of varying size without departing from the Applicant's invention.

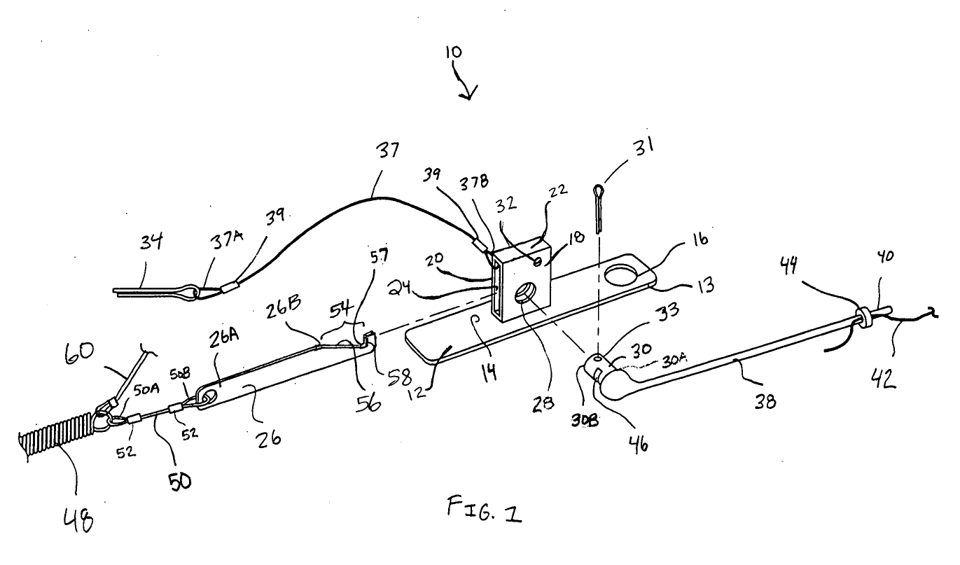

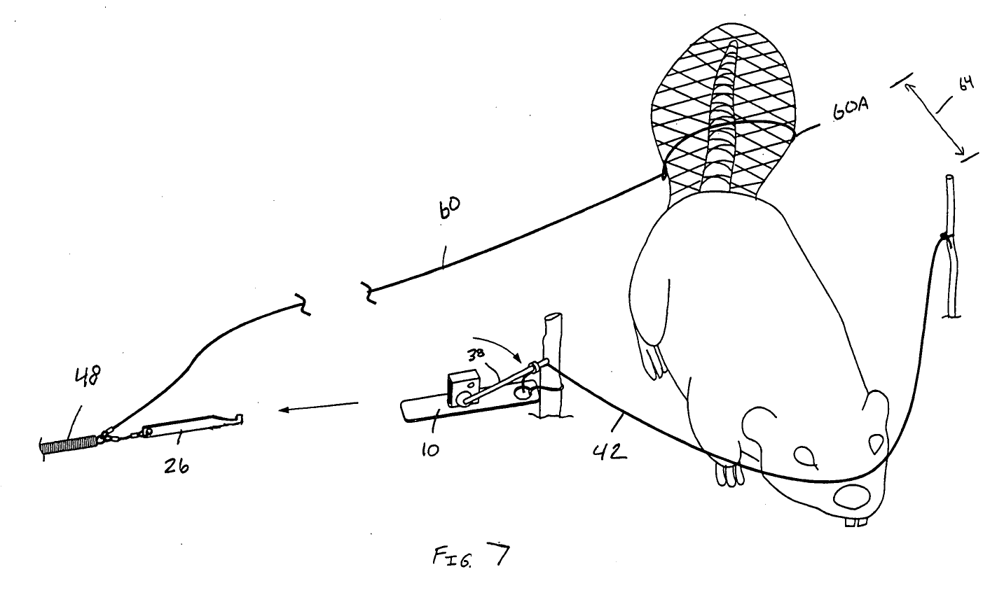

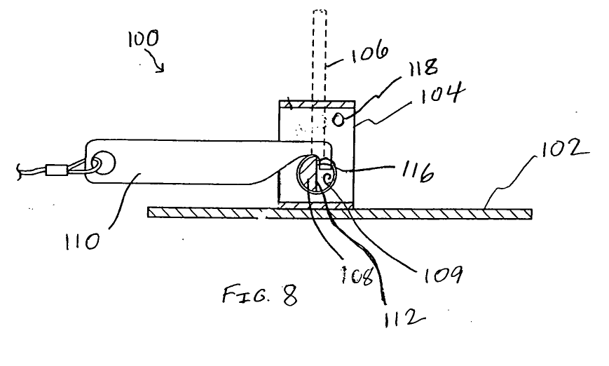

Referring now to the drawings in more detail, there are shown exemplary embodiments of the present disclosure. FIG. 1 shows an exploded view of a snare trigger assembly 10 pursuant to one embodiment of the present disclosure. Assembly 10 comprises an elongated base member 12 having a top surface 14 and a bottom surface (not explicitly shown). Both the top surface 14 and the bottom surface are substantially flat and are separated by a side wall 13. The base member 12 includes a hole 16 that may be used for anchoring the entire assembly 10. For example, an anchoring stake may be driven through hole 16 or the hole 16 may be used to attach the entire assembly 10 to a stake (see FIGS. 6 and 7) or other fixed location by use of a chain or the like. It will be appreciated that anchoring the assembly 10 prevents an animal caught in the snare from dragging the assembly away from the trapping location. Further, it should be noted that any anchoring means or method suitable able to accomplish the purpose described above should be deemed to fall within the scope of the present disclosure.

Extending upwardly from the base member 12 are walls 18 and 20. Walls 18 and 20 are generally parallel to each other. Extending across the top of the walls 18 and 20 is a cross piece 22. The cross piece 22 provides support for the walls 18 and 20. The walls 18 and 20 are spaced apart to thereby define a slot 24 between opposing inner surfaces of the walls 18 and 20. The width and height of the slot 24 is sufficient to allow a catch 26 to be inserted therein as will be explained further below.

The slot 24 is protected from debris and the like by the walls 18 and 20 themselves, as well as the cross piece 22. The debris may otherwise interfere with the operation of the assembly 10 by causing premature springing of the trap or preventing the trap from springing at all. Offending debris may include dirt, snow, ice and/or mud. It will be appreciated that the walls 18 and 20 and the cross piece 22 together comprise a frame, and may be referred to herein as one example of a frame suitable for use with the present disclosure. Any frame or other structure suitable to accomplish the purposes set forth herein falls within the scope of the present disclosure.

A mounting bore 28 extends completely through each of the walls 18 and 20. The bore 28 is adapted to receive a cylindrical shaft 30 as will also be explained below. It will be noted that shaft 30 does not necessarily have to be cylindrical, and that shaft 30 and other suitable structures may be referred to herein as rotatable members.

A second bore 32 is located above the bore 28 and also extends through walls 18 and 20. The second bore 32 is adapted to receive a pin 34. As will be explained in more detail below, the pin 34 and bore 32 are operable to act collectively as a safety mechanism that prevents the trigger assembly 10 from being sprung until the appropriate time. The pin 34 may be connected to the trigger assembly 10 by a cord 37 as shown in FIG. 1. In particular, cord 37 includes looped ends 37A and 37B for coupling the cord 37 to the pin 34 and trigger assembly 10, respectively. Crimps 39 may be employed to form the looped ends 37A and 37B in the cord 37. The use of cord 37 is optional, but important, as its purpose is to prevent pin 34 from being lost or otherwise misplaced.

As previously mentioned, the cylindrical shaft 30 is mounted in the bore 28. The mounting should allow shaft 30 to freely rotate in bore 28 around an axis of rotation, and, therefore, the diameter of the bore 28 is just slightly larger than the diameter of the shaft 30. A lever 38 extends from an end 30A of the shaft 30 generally perpendicular to the axis of rotation of the shaft 30. It will be noted that the lever 38 may extend non-perpendicularly to the shaft 30. The lever 38 may extend several inches or more such that the lever 38 is sufficient to provide a torque on the shaft 30 in response to a force applied to the lever 38.

Attached to a free end 40 of the lever 38 is a trip wire 42. The trip wire 42 typically provides the force to the lever 38 as described in the preceding paragraph. As mentioned, the purpose of the lever 38 and the trip wire 42 is to rotate the shaft 30 from a set position to a sprung position in response to an animal tripping the trip wire 42. The trip wire 42 is typically strung across an anticipated path of an animal and is pulled away from the assembly 10 by the animal as shown in FIGS. 6 and 7.

The trip wire 42 is attached to the free end 42 of the lever 38 by an annular resilient member 44. The resilient member 44 allows for easy adjustment of the length of the trip wire 42. It will be appreciated by those having skill in the art that the trip wire 42 may be attached to the lever 38 in any suitable manner such that the trip wire 42 and lever 38 accomplish the functions as described herein. For example, the trip wire 42 may be simply tied or otherwise attached to the lever 38. However, it is convenient to provide a means for adjusting the trip wire 42 at the trigger assembly 10 so that it may be strung tightly across the anticipated path of an animal. Further, the resilient member 44 allows for minor adjustments in the trap once it has been set.

A recess 46 is formed in the shaft 30. The recess 46 is disposed in a portion of the shaft 30 such that the recess 46 resides in the slot 24 formed between walls 18 and 20 when the shaft 30 is installed into the bore 28. The recess 46 is configured and dimensioned to engage the catch 26 to thereby hold a resilient member 48 coupled to the catch 26 under tension. When the catch 26 is engaged in the recess 46 such that the resilient member 48 is under tension, this is known as the set position. That is, the trap is set and can be sprung if the lever 38 is moved. Conversely, the sprung position is when the catch 26 and the recess 46 are not engaged. Thus, the trigger assembly 10 has to be reset when in the sprung position to be operable.

The catch 26 is an elongate member of sufficiently small width such that it can enter into slot 24. A rear portion 26A of the catch 26 is coupled to the resilient member 48 by a coupler 50, such as a piece of wire or the like. It will be appreciated by those having skill in the art that the coupling mechanism between the catch 26 and the resilient member 48 may be made in any suitable manner to accomplish the features described herein. Further, it will be appreciated that the resilient member 48 may have integrated therein the necessary structure to function as the catch 26. That is, no independent catch 26 may be required. Referring still to FIG. 1, the coupler 50 includes loops 50A and 50B to thereby couple the catch 26 and resilient member 48 together. Crimps 52 may be used to form the loops 50A and 50B in the free ends of coupler 50.

A top front portion 26B of the catch 26 includes a shaft engagement portion 54. The shaft engagement portion 54 includes a downwardly sloping surface 56 whose slope tapers off near an apex 57. Extending upwardly from the apex 57 is an engagement surface 58, which extends to the top of the catch 26. The shaft engagement portion 54 of the catch 26 thus has a shape roughly equivalent to a hook and may be referred to herein as a hooked portion. The shaft engagement portion 54, and in particular, the engagement surface 58 engages the recess 46 in the cylindrical shaft 30 to maintain the resilient member 48 under tension. The engagement surface 58 and the shaft 30 engage each other in a slip-free manner. That is, the catch 26 should only disengage from the shaft 30 when the trap is actually triggered.

It will be appreciated that the structure and apparatus disclosed herein is merely one example of a means for maintaining a resilient member under tension, and it should be appreciated that any structure, apparatus, or system for maintaining a resilient member under tension which performs functions the same as, or equivalent to, those disclosed herein are intended to fall within the scope of a means for maintaining a resilient member under tension, including those structures, apparatuses, or systems for maintaining a resilient member under tension which are presently known, or which may become available in the future. Anything that functions the same as, or equivalently to, a means for maintaining a resilient member under tension falls within the scope of this element.

As used herein, the term “resilient member” refers to any device or material having as a characteristic the ability to return to its original shape or position after being pushed, pulled, or pressed in response to a force. It will be appreciated that the present disclosure is not restricted to any particular type of resilient member for tightening the loop of a snare, and that suitable resilient members, include, without limitation, metal and plastic springs, elastic cords, and any other similar type device.

It will be further appreciated that the structure and apparatus disclosed herein is merely one example of a resilient means for tightening the loop of a snare, and it should be appreciated that any structure, apparatus, or system for tightening the loop of a snare that performs functions the same as, or equivalent to, those disclosed herein is intended to fall within the scope of a means for tightening the loop of a snare, including those structures, apparatuses, or systems for tightening the loop of a snare that are presently known, or that may become available in the future. Anything that functions the same as, or equivalently to, a resilient means for tightening the loop of a snare falls within the scope of this element.

A bore 33 is also formed in the shaft 30. The bore 33 is adapted to receive a pin 31. The purpose of pin 31 and bore 33 is to maintain the shaft 30 in bore 28. It will be appreciated by those having skill in the art that alternative designs and structure may be suitable for holding shaft 30 in the bore 28 in addition those disclosed herein, and that any such alternative design and structure is within the scope of the present disclosure.

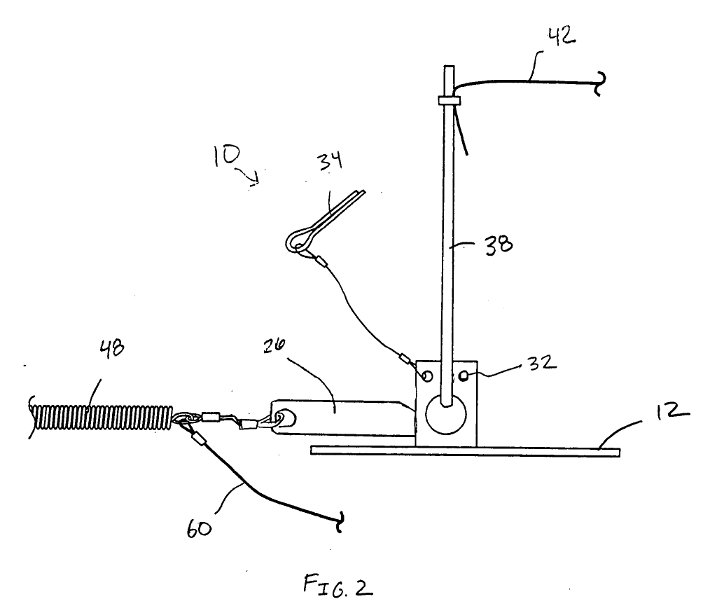

Referring now to FIG. 2, there is shown a side view of the trigger assembly 10 in the previously described set position. The reader will recall that the set position entails the catch 26 being inserted into slot 24 and engaging the shaft 30 to thereby maintain the resilient member 48 under tension. In the set position, the lever 38 extends in a substantially vertical direction with respect to the base member 12. One end of the trip wire 42 is attached to the lever 38 and the rest of the trip wire 42 is extended across the anticipated path of the animal as is best shown in FIG. 6, with the other end of the trip wire 42 being connected to a fixed object, such as a stake or tree.

In the set position, the resilient member 48 is under tension, as the opposite end of the resilient member 48 should be attached to a fixed object, such as a stake or natural object. The resilient member 48 is stretched and the catch 26 is engaged to the cylindrical shaft 30 when the trap is set. FIGS. 2 and 6 further shows a snare 60 having a loop 60A (FIG. 6 only) vertically suspended over the anticipated path of the animal as is well known in the art and, therefore, not described in detail herein. Although not explicitly shown, the loop 60A may include a one-way device for allowing the loop to tighten but not untighten. The loop 60A is generally formed by slidably attaching the end of the snare 60 to itself. When placed, the loop 60A should be of sufficient size allow an animal to pass through the loop 60A until the animal hits the trip wire 42.

The snare 60 itself may be formed from a cable, wire, rope, cord, or any other suitable material as known to those having skill in the art. The loop 60A is typically of variable diameter and may be tightened by pulling on the opposite end of the snare 60, that is, the end of the snare 60 connected to the resilient member 48. Thus, the un-looped end of the snare 60 should be attached to the resilient member 48.

Describing now in more detail the engagement of catch 26 and shaft 30, FIG. 4 illustrates a cross-sectional view of the trigger assembly 10 in the set position taken along a longitudinal axis of the assembly 10. As previously mentioned, in the set position, a portion of the catch 26 extends into the slot 24 formed between walls 18 and 20.

The recess 46 formed in the shaft 30 has a first engagement wall 62 that is substantially vertical while the shaft 30 is in the set position and a second engagement wall 62A that is approximately perpendicular to the first engagement wall 62. The downwardly sloping surface 56 allows the engagement surface 58 of the hooked portion of the catch 26 to engage the first engagement wall 62 of the recess 46 as shown in FIG. 4. It will be appreciated that the relative juxtapositions of the first engagement wall 62 and the second engagement wall 62A can be modified to change the amount of force that is needed to spring the snare. It will be appreciated that the resilient member 48 biases the catch 26 rearward, and but for the engagement of the catch 26 with the shaft 30, the resilient member 48 would snap rearward and away from the trigger assembly 10.

It will be appreciated that the structure and apparatus disclosed herein is merely one example of a means for releasing a resilient member in response to an animal tripping a trip wire, and it should be appreciated that any structure, apparatus, or system for releasing a resilient member in response to an animal tripping a trip wire that performs functions the same as, or equivalent to, those disclosed herein are intended to fall within the scope of a means for releasing a resilient member in response to an animal tripping a trip wire, including those structures, apparatuses, or systems for releasing the resilient member in response to an animal tripping a trip wire that are presently known, or that may become available in the future. Anything that functions the same as, or equivalently to, a means for a resilient member in response to an animal tripping a trip wire falls within the scope of this element.

Referring now to the safety mechanism, as described previously, pin 34 may be inserted into hole 32. It will be understood that while pin 34 is inserted into hole 32, catch 26 is prevented from disengaging with shaft 30. More precisely, with pin 34 inserted into hole 32, a portion of the pin 34 extends across slot 24 defined between walls 18 and 20. This portion of the pin 34 prevents the lever 38 from moving forward to disengage shaft 30, even if the trip wire 42 is tripped. This may allow for the placement of bait or concealment of the trigger assembly 10 without the worry that the trap will be inadvertently sprung. Alternative arrangement of the safety mechanism may provide for a pin that blocks the movement of the catch 26 or the rotation of the shaft 30. These alternative arrangements should be considered within the scope of the present disclosure.

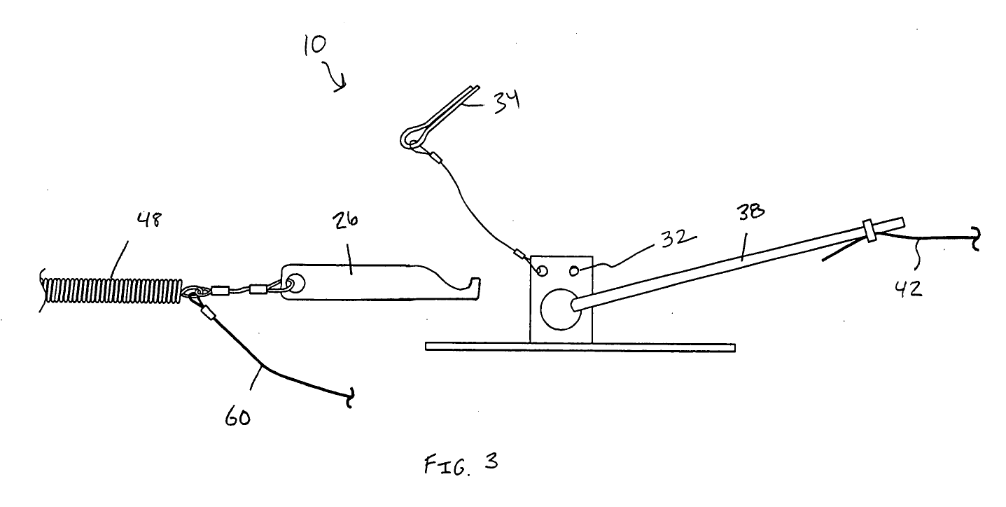

Referring now to FIG. 3, there is shown the assembly 10 in a sprung position. As can be observed, the lever 38 extends in nearly a horizontal direction and catch 26 has become disengaged from the shaft 30. In other words, the lever 38 has rotated forward in response to a force from trip wire 42. As can be observed most clearly in FIG. 7, the trap is sprung when an animal trips the trip cord 42. That is, as the animal moves forward through the trap zone, the trip cord 42 pulls the lever 38 forward to nearly the horizontal position. The lever 38 exerts a torque on the shaft 30 to thereby rotate the shaft 30 from the set position into the sprung position. The catch 26 is released from the shaft 30 and the resilient member 48 is biased rearward to thereby pull closed the loop 60A on the snare 60. It will be appreciated that the catch 26 may be released before the lever 38 reaches the position shown in FIG. 3. In particular, the trap may be sprung after the lever 38 swings through only a few degrees of rotation.

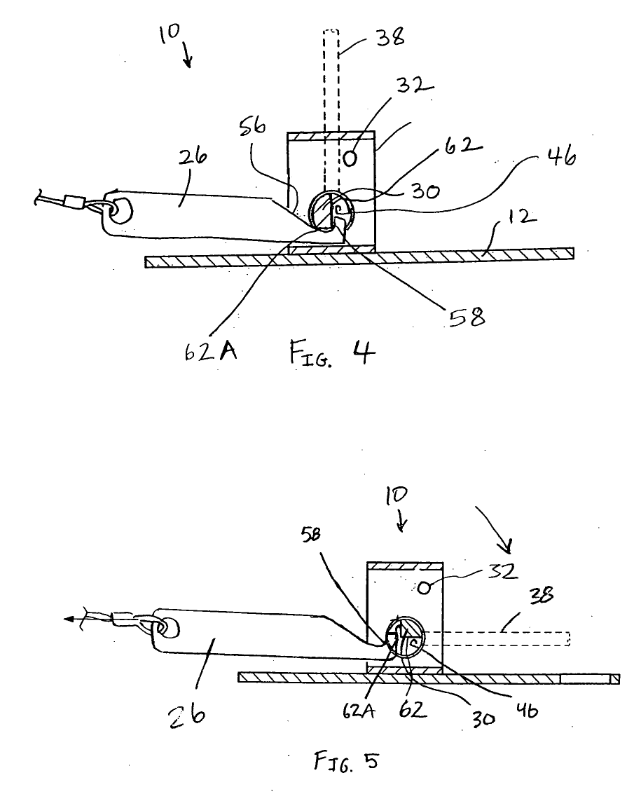

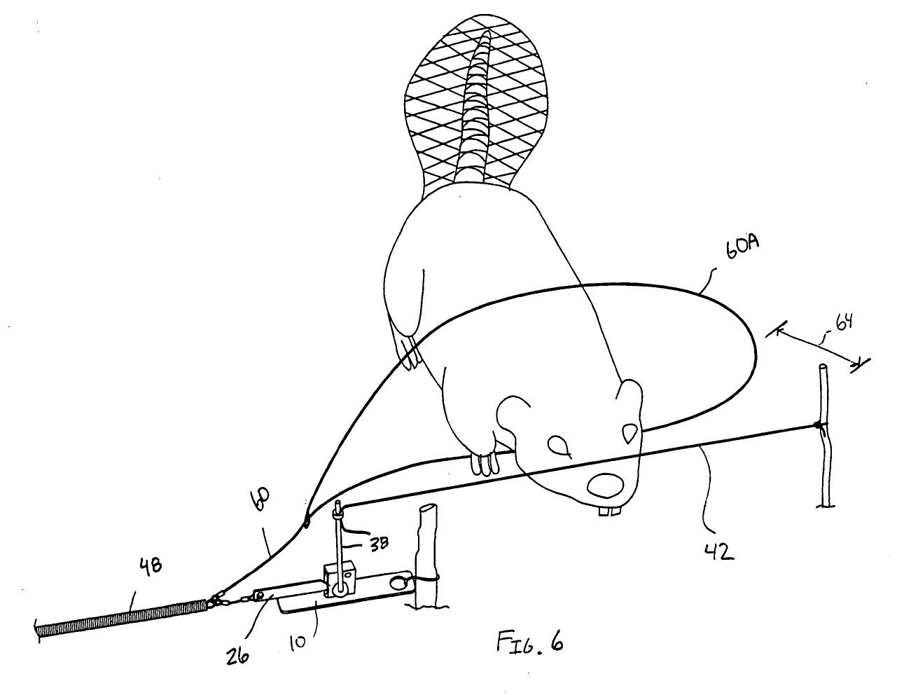

As illustrated in FIG. 5, there is shown a cross-sectional view of the trigger assembly 10 just after the trap has been sprung. When the lever 38 is pulled forward by the trip wire 42, the shaft 30 rotates forward around its rotational axis due to the torque exerted by the lever 38. The recess 46, as part of the shaft 30, also rotates forward to thereby effectively disengage the first engagement wall 62 of the recess 46 from the engagement surface 58 of the catch 26. The catch 26 also moves slightly upward in the slot 24 as the resilient member 48 pulls the catch 26 rearward and away from the trigger assembly 10. Without the engagement of the engagement surface 58 of the catch 26 with the first engagement wall 62 of the recess 46, there is nothing holding the catch 26 in place. Of course, if the safety mechanism, the pin 34, had been placed in the bore 32, then the catch 26 could not be disengaged from the shaft 30. It will be appreciated that the catch 26 and the resilient member 48 are not integral with the rest of the trigger assembly 10, including the frame. That is, the catch 26 and the resilient member 48 are physically detached from the rest of the trigger assembly 10.

One advantage to the detached catch 26 and resilient member 48 is that the trapper may easily vary the strength of the resilient member 48. For example, the trapper may link several springs together for larger animals or may decrease the number of springs for smaller animals. Moreover, the trapper may use resilient members 48 of varying sizes and force depending on the needs of the situation. Further, by having the resilient member 48 separate from the main assembly 10, the cost of manufacture of the assembly 10 is significantly reduced by its simplified complexity over the previously available traps. The detached catch 26 allows almost any resilient member 48 to be used with the assembly 10 since all that needs to be done is to attach the catch 26 to the resilient member 48.

Referring now to FIGS. 6 and 7, one advantage of the present disclosure is that it allows a more significant separation of the trip wire 42 and the loop 60A of the snare 60 than is possible by trip plate type traps. This distance is marked by the double arrow line indicated by reference numeral 64. This is advantageous due to the fact that, in the case of a beaver, the loop 60A may be set significantly behind the trip wire 42 such that the loop 60A catches the beaver by its tail as shown in FIG. 7. This prevents the pelt of the beaver from being damaged by the loop 60A as the tail of a beaver is not part of the pelt.

The trigger assembly 10 may be constructed entirely of metal, such as steel or a suitable alloy, although other types of materials known in the art would suffice. Parts or all of the assembly 10 could be made from plastic or other high strength material capable of withstanding adverse weather conditions present during a typical trapping season.

To set the trigger assembly 10, the following exemplary steps may be employed. It will be understood that the foregoing steps are exemplary only, and more or fewer steps, even in a different order, may be employed with Applicant's invention. Typically, the trigger assembly 10 is located near a game trail. A suitable bait or other attractant may also be used. The base member 12 is anchored either to a stake, the ground, or any other immovable object. One end of the resilient member 48 is also anchored to a stake, the ground or any other immovable object. This is necessary because the resilient member 48 is detached from the base member 12.

The resilient member 48 is stretched until the catch 26 is able be inserted into slot 24. The hooked portion of the catch 26 is “hooked” to the shaft 30. At this time, the safety pin 34 may be inserted into bore 32 to prevent a premature springing of the trap. The trip wire 42 is strung across the anticipated path of the animal and affixed to an immovable object, such as a stake. The tension in the trip wire 42 may be adjusted at the lever 38 such that it is tight across the trail. The loop 60A is then properly positioned in the desired location. For example, the loop 60A may be deployed in a vertical manner or laid on the ground. Further, the loop 60A may be positioned some distance behind the trip wire 42 such that the loop 60A will ensnare the tail of the animal. The trigger assembly 10 may be camouflaged. Lastly, the safety pin 34 is removed such that the trap is ready to be sprung.

FIG. 8 illustrates another embodiment of the present invention. FIG. 8 is a cross-sectional view of a trigger assembly 100. Assembly 100 comprises a base member 102, a frame 104, a lever 106 (shown in phantom), a rotatable member 108, a recess 109, and a catch 110 having the similar functionality as previously described. The assembly 100 differs from the embodiments previously described in the configuration of recess 109 and the engagement of the catch 110 to the recess 109. As seen in FIG. 8, the catch 110 engages the top side of the rotatable member 108. The catch 110 may have the same configuration as previously described. The recess 109 in the rotatable member 108 is configured differently. The recess 109 comprises an engagement wall 112. The hooked portion 116 of the catch engages the engagement wall 112. Again, the catch 110 is released when the lever 106 is pulled forward and rotates the rotatable member 108. It will be appreciated that the hooked portion 116 of the catch 110 may only be installed or released from the rotatable member 108 when the rotatable member 108 is in the sprung position, that is rotated forward. It should be noted that bore 118 may receive a pin to thereby prevent the lever 106 from moving forward to spring the trap.

Those having ordinary skill in the relevant art will appreciate the advantages provide by the features of the present disclosure. For example, it is a feature of the present disclosure to provide a trigger assembly for snare type traps that is simple yet effective to use. Another feature of the present disclosure to provide a low cost and simple-to-manufacture trigger assembly for snare type traps. It is a further feature of the present disclosure, in accordance with one aspect thereof, to provide a trigger assembly for snare type traps that minimizes pelt damage.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly, and use may be made without departing from the principles and concepts set forth herein.

What is claimed is:

1. A snare trigger assembly for trapping animals using a snare, the snare having a loop of variable dimension, the snare trigger assembly comprising:
a frame;
a rotatable member mounted to the frame, the rotatable member positionable between a set position and a sprung position;
a lever operable to move the rotatable member in the frame from the set position to the sprung position in response to an animal tripping a trip wire connected to the lever;
a resilient member for tightening the loop of the snare; and
a catch configured and dimensioned for engaging the rotatable member when the rotatable member is in the set position such that the resilient member is held under tension and for disengaging from the rotatable member when the rotatable member is moved to the sprung position to thereby allow the resilient member to tighten the loop of the snare;
wherein the catch and the resilient member are detached from the frame.

2. The assembly of claim 1 wherein the frame comprises two walls and a base member, the two walls extending upwardly from the base member and defining a slot between each other, and wherein at least a portion of the rotatable member extends across the slot.

3. The assembly of claim 2 wherein the catch engages to and disengages from that portion of the rotatable member extending across the slot.

4. The assembly of claim 1 wherein the rotatable member comprises a recessed portion and the catch comprises a hooked portion, said hooked portion of the catch engaging the recessed portion of the rotatable member when the rotatable member is in the set position as to hold the resilient member under tension.

5. The assembly of claim 1 wherein the rotatable member is a cylindrical shaft.

6. The assembly of claim 5 wherein the lever is coupled to the cylindrical shaft.

7. The assembly of claim 6 wherein the cylindrical shaft has an axis of rotation, and wherein the lever extends perpendicular to the axis of rotation of the shaft.

8. The assembly of claim 7 further comprising a pin, and wherein the cylindrical shaft further comprises a bore for removably receiving the pin, the pin and the bore operating to hold the shaft to the frame.

9. The assembly of claim 1 wherein the frame defines a slot, and at least a portion of the rotatable member extends across the slot.

10. The assembly of claim 9 wherein the catch engages to and disengages from that portion of the rotatable member extending across the slot.

11. The assembly of claim 1 further comprising a safety mechanism for preventing the catch from accidentally disengaging from the rotatable member.

12. The assembly of claim 11 wherein the safety mechanism comprises a pin and a bore in the frame, the bore being sized to removably receive the pin to thereby prevent the catch from disengaging the rotatable member.

13. The assembly of claim 1 further comprising a second resilient member for attaching the trip wire to the lever.

14. The assembly of claim 1 wherein the resilient member is coupled to the snare.

15. A snare trigger assembly for trapping animals using a snare, the snare having a loop of variable dimension, the snare trigger assembly comprising:
a resilient means for tightening the loop of the snare;
a means for maintaining the resilient means under tension; and
a means for releasing the resilient means in response to an animal tripping a trip wire.

16. The assembly of claim 15 further comprising a safety means for preventing the loop from being tightened prematurely.

17. The assembly of claim 15 further comprising an anchoring means for securing at least a portion of the assembly to a stake.

18. The assembly of claim 15 wherein the means for maintaining the resilient means under tension comprises a catch having a hooked portion.

19. The assembly of claim 15 wherein the means for maintaining the resilient means under tension comprises a cylindrical shaft.

20. The assembly of claim 15 wherein the means for releasing the resilient means comprises a lever.

21. A snare trigger assembly for trapping animals using a snare, the snare having a loop of variable dimension, the snare trigger assembly comprising:
a resilient member for tightening the loop of the snare around an animal;
an elongated base member having a top surface and a bottom surface;
a first wall and a second wall each extending upwardly from the top surface of the base member, the first and second walls each having an outer surface, an inner surface, and an upper most portion;
the inner surfaces of the first and second walls defining a narrow slot;
a cross piece extending laterally from the upper most portion of the first wall to the upper most portion of the second wall;
a first bore extending through both the first wall and the second wall;
a cylindrical shaft rotatably mounted in the first bore such that a portion of the cylindrical shaft is disposed in the slot;
the cylindrical shaft being operable between a set position and a sprung position;
a recess formed in that portion of the cylindrical shaft residing in the slot;
a lever coupled to the cylindrical shaft, the lever being operable to move the cylindrical shaft from the set position to the sprung position in response to an animal tripping a trip wire;
a catch coupled to the resilient member, the catch being configured and dimensioned to fit into the slot between the first and second walls; and
a hooked portion integral with the catch, the hooked portion being configured and dimensioned for engaging the recess in the cylindrical shaft while the shaft is in the set position to thereby maintain the resilient member under tension;
wherein the hooked portion of the catch is disengaged from the recess in the cylindrical shaft when the shaft is moved to the sprung position to thereby permit the resilient member to tighten the loop of the snare.

22. The snare trigger assembly of claim 21 further comprising a pin and a second bore, wherein the second bore extends through the first and second walls, the second bore being configured and dimensioned for receiving the pin to thereby prevent the catch from accidently disengaging the cylindrical shaft.

23. The snare trigger assembly of claim 21 wherein the catch is not attached to other parts of the assembly other than the resilient member.

24. The snare trigger assembly of claim 23 further comprising a hole in the base member for anchoring the base member to an object.
